(19) United States
(12) Patent Application Publication
(10) Pub. No.: US 2024/0253395 A1
(43) Pub. Date: Aug. 1, 2024

(54) HIGH-PERFORMANCE TYRE

(71) Applicant: Pirelli Tyre S.p.A., Milano (IT)

(72) Inventors: Ivan MANGILI, Milano (IT); Francesca BAIONE, Milano (IT); John Nazareno HOUSE, Milano (IT); Valeria Rosaria CIPOLLETTI, Milano (IT)

(73) Assignee: Pirelli Tyre S.p.A., Milano (IT)

(21) Appl. No.: 18/564,307

(22) PCT Filed: May 31, 2022
(86) PCT No.: PCT/IB2022/055077

§ 371 Date: Nov. 27, 2023

(30) Foreign Application Priority Data
Jun. 3, 2021 (IT) 102021000014432

(51) Int. Cl. B60C 1/00; B60C 11/00; C08K 5/00; C08L 9/06

(52) U.S. Cl. CPC B60C 1/0016; B60C 11/0008; C08K 5/0025; C08L 9/06; B60C 2011/0025; C08L 2205/025

(57) ABSTRACT

The present invention relates to a high-performance tyre for vehicle wheels comprising a tread made with a vulcanised elastomeric compound obtained by vulcanising a vulcanisable elastomeric compound comprising (i) a composition of elastomeric polymers consisting of at least one high Tg styrene-butadiene polymer (SBR) and optionally at least one low Tg isoprene (IR) polymer and (ii) a resin mixture consisting of at least one low Tr resin, at least one high Tr resin, and optionally at least one resin with intermediate Tr.

### FIELD OF THE INVENTION

The present invention relates to a high-performance tyre for vehicle wheels, in particular cars and motorcycles. In particular, the present invention relates to a high-performance tyre tread comprising a vulcanised elastomeric compound obtained by vulcanising a vulcanisable elastomeric compound comprising (i) a composition of elastomeric polymers consisting of at least one high Tg (glass transition temperature) styrene-butadiene (SBR) polymer and optionally at least one low Tg isoprene (IR) polymer and (ii) a resin mixture consisting of at least one low Tr (softening temperature) resin, at least one high Tr resin, and optionally at least one resin with intermediate Tr.

### PRIOR ART

In the tyre industry, research pursues the goal of increasing driving safety along with increasing overall performance.

In particular, high-performance tyres, both in the automotive and motorcycle fields, are designed to be used at high speeds and allow high adhesion (grip), particularly during changes of direction or high-speed manoeuvres.

Said tyres for high-performance sports motor vehicles or motorcycles, which are commonly referred to as “HP” and “UHP” (“High-performance” and “Ultra high-performance”), are in particular, but non-exclusively, those according to E.T.R.T.O. standards—(European Technical Organization for Tyres and Rims) speed codes: “T”, “U”, “H”, “V”, “Z”, “W”, “Y” which correspond to maximum speeds over 190 Km/h and up to over 300 Km/h, for which operating performance at high temperatures are required.

Traditionally, the elastomeric compositions used for the production of high-performance tyre treads are based on styrene-butadiene copolymers (SBR) and are characterised by high glass transition temperature (Tg) values (i.e., above −50° C.).

Such elastomeric compositions are characterised by a high hysteresis (Tan δ) and a low elastic dynamic modulus (E′) at high temperatures, which allow optimal performance at high temperatures through an increase in the Tan δ/E′ ratio, such ratio being indicative of the tyre grip performance.

Furthermore, to further improve the grip performance at high temperature, typical working conditions of high-performance tyres, the elastomeric compositions used include plasticisers with a high softening temperature (Tr), generally between 50° C. and 100° C. The most commonly used plasticisers are resins comprising styrene and/or other aromatic and/or polar groups (for example, α-methyl-styrene, styrene-indene, phenolic, terpenic and similar resins), characterised by a low molecular weight (PM), typically lower than 2,000 and with a high styrene content (and/or other aromatic and/or polar groups), for example, equal to at least 25% by weight, and preferably also up to 100% by weight.

Due to their low molecular weight and high styrene content (and/or other aromatic group and/or polar group), the aforementioned resins are used to modulate the hysteresis of the tyre tread and, since they are solubilised, in all or in part, in the elastomeric compositions, they also modulate the glass transition temperature (Tg), causing an increase in value thereof.

The use of plasticisers in elastomeric compounds for high-performance tyre treads is known in the art, for example in WO2021/005295A1, WO2017/046766A1, WO2014/191953, WO2013/039499A1, WO2012/012133A1, and EP2468815.

### SUMMARY OF THE INVENTION

The Applicant has faced the problem of extending the working temperature range in high-performance tyres capable of offering optimal performance in terms of grip both at high temperatures on dry surfaces and at low temperatures on wet surfaces, without penalising the features of processability, mechanical strength and wear resistance.

The Applicant has undertaken studies aimed at giving the elastomeric compounds for tyres the desired properties discussed above and, after extensive experimentation has found that, by appropriately selecting the nature and quantity of the elastomeric polymers and plasticisers, it was possible to obtain improved grip performance both at high and low temperatures, without penalising the features of processability, mechanical strength and wear resistance.

In particular, the Applicant has surprisingly found that the use of a mixture of two or more plasticisers, each with a specific softening temperature, respectively low, medium or high, in an elastomeric composition characterised by a high Tg, was able to provide higher values of the tan δ/E′ ratio for a wider temperature range, between 5° C.-25° C., indicative of performance on wet surfaces, and 70° C.-100° C., indicative of performance on dry surfaces.

The present invention therefore relates to a tyre for vehicle wheels comprising:
a carcass structure, having opposite side edges associated with respective bead structures;
optionally, a belt structure applied in a radially external position with respect to said carcass structure;
a tread band applied in a radially external position with respect to said carcass and/or belt structure;
characterised in that said tread band comprises a vulcanised elastomeric compound obtained by vulcanisation of a vulcanisable elastomeric compound made by mixing an elastomeric composition, wherein said elastomeric composition comprises
(i) 100 phr of an elastomeric polymer composition comprising, preferably consisting of:
   a. at least one styrene-butadiene polymer (SBR) having a Tg ranging from −45° C. to −15° C. in an amount ranging from 40 to 100 phr, and
   b. optionally, from 0 to 30 phr of at least one isoprene polymer (IR) having a Tg ranging from −80° C. to −50° C.,
(ii) 10 to 50 phr of a resin mixture comprising, preferably consisting of:
   a. at least one resin with a softening temperature lower than 50° C. in an amount ranging from 5 to 45 phr,
   b. at least one resin with a softening temperature higher than 110° C. in an amount ranging from 5 to 45 phr, and
   c. optionally, from 0 to 40 phr of at least one resin with a softening temperature between 50° C. and 110° C.,
(iii) at least one reinforcing filler in an amount ranging from 1 to 130 phr, and
(iv) at least one vulcanising agent in an amount ranging from 0.1 to 12 phr.

In a second aspect thereof, the present invention also relates to a vulcanisable elastomeric compound obtained by mixing an elastomeric composition, wherein said elastomeric composition comprises
(i) 100 phr of an elastomeric polymer composition comprising, preferably consisting of:
   a. at least one styrene-butadiene polymer (SBR) having a Tg ranging from −45° C. to −15° C. in an amount ranging from 40 to 100 phr, and
   b. optionally, from 0 to 30 phr of at least one isoprene polymer (IR) having a Tg ranging from −80° C. to −50° C.,
(ii) 10 to 50 phr of a resin mixture comprising, preferably consisting of:
   a. at least one resin with a softening temperature lower than 50° C. in an amount ranging from 5 to 45 phr,
   b. at least one resin with a softening temperature higher than 110° C. in an amount ranging from 5 to 45 phr, and
   c. optionally, from 0 to 40 phr of at least one resin with a softening temperature between 50° C. and 110° C.,
(iii) at least one reinforcing filler in an amount ranging from 1 to 130 phr, and
(iv) at least one vulcanising agent in an amount ranging from 0.1 to 12 phr.

### Definitions

The term “elastomeric composition” means a composition comprising at least one diene elastomeric polymer and one or more additives, which by mixing and possible heating provides an elastomeric compound suitable for use in tyres and components thereof.

The components of the elastomeric composition are not generally introduced simultaneously into the mixer but typically added in sequence. In particular, the vulcanisation additives, such as the vulcanising agent and possibly the accelerant and retardant agents, are usually added in a downstream step with respect to the incorporation and processing of all the other components.

In the final vulcanisable elastomeric compound, the individual components of the elastomeric composition may be altered or no longer individually traceable as modified, completely or in part, due to the interaction with the other components, of heat and/or mechanical processing. The term “elastomeric composition” herein is meant to include the set of all the components that are used in the preparation of the elastomeric compound, regardless of whether they are actually present simultaneously, are introduced sequentially or are then traceable in the elastomeric compound or in the final tyre.

The term “elastomeric polymer” indicates a natural or synthetic polymer which, after vulcanisation, may be stretched repeatedly at room temperature to at least twice its original length and after removal of the tensile load substantially immediately returns with force to approximately its original length (according to the definitions of the ASTM D1566-11 Standard terminology relating to Rubber).

The term “diene polymer” indicates a polymer or copolymer derived from the polymerisation of one or more different monomers, among which at least one of them is a conjugated diene (conjugated diolefin).

The term “elastomeric compound” indicates the compound obtainable by mixing and possibly heating at least one elastomeric polymer with at least one of the additives commonly used in the preparation of tyre compounds.

The term “vulcanisable elastomeric compound” indicates the elastomeric compound ready for vulcanisation, obtainable by incorporation into an elastomeric compound of all the additives, including those of vulcanisation.

The term “vulcanised elastomeric compound” means the material obtainable by vulcanisation of a vulcanisable elastomeric compound.

The term “green” indicates a material, a compound, a composition, a component or a tyre not yet vulcanised.

The term “vulcanisation” refers to the cross-linking reaction in a natural or synthetic rubber induced by a typically sulphur-based cross-linking agent.

The term “vulcanising agent” indicates a product capable of transforming natural or synthetic rubber into elastic and resistant material by virtue of the formation of a three-dimensional network of inter- and intra-molecular bonds. Typical vulcanising agents are sulphur-based compounds such as elemental sulphur, polymeric sulphur, sulphur-donor agents such as bis[(trialkoxysilyl)propyl]polysulphides, thiurams, dithiodimorpholines and caprolactam-disulphide.

The term “vulcanisation accelerant” means a compound capable of decreasing the duration of the vulcanisation process and/or the operating temperature, such as sulphenamides, thiazoles, dithiophosphates, dithiocarbamates, guanidines, as well as sulphur donors such as thiurams.

The term “vulcanisation activating agent” indicates a product capable of further facilitating the vulcanisation, making it happen in shorter times and possibly at lower temperatures. An example of activating agent is the stearic acid-zinc oxide system.

The term “vulcanisation retardant” indicates a product capable of delaying the onset of the vulcanisation reaction and/or suppressing undesired secondary reactions, for example N-(cyclohexylthio)phthalimide (CTP).

The term “vulcanisation package” is meant to indicate the vulcanising agent and one or more vulcanisation additives selected from among vulcanisation activating agents, accelerants and retardants.

The term “reinforcing filler” is meant to refer to a reinforcing material typically used in the sector to improve the mechanical properties of tyre rubbers, preferably selected from among carbon black, conventional silica, such as silica from sand precipitated with strong acids, preferably amorphous, diatomaceous earth, calcium carbonate, titanium dioxide, talc, alumina, aluminosilicates, kaolin, silicate fibres and mixtures thereof.

The term “white filler” is meant to refer to a conventional reinforcing material used in the sector selected from among conventional silica and silicates, such as sepiolite, paligorskite also known as attapulgite, montmorillonite, alloisite and the like, possibly modified by acid treatment and/or derivatised. Typically, white fillers have surface hydroxyl groups.

The term “mixing step (1)” indicates the step of the preparation process of the elastomeric compound in which one or more additives may be incorporated by mixing and possibly heating, except for the vulcanising agent which is fed in step (2). The mixing step (1) is also referred to as “non-productive step”. In the preparation of a compound there may be several “non-productive” mixing steps which may be indicated with 1a, 1b, etc.

The term “mixing step (2)” indicates the next step of the preparation process of the elastomeric compound in which the vulcanising agent and, possibly, the other additives of the vulcanisation package are introduced into the elastomeric compound obtained from step (1), and mixed in the material, at controlled temperature, generally at a compound temperature lower than 120° C., so as to provide the vulcanisable elastomeric compound. The mixing step (2) is also referred to as “productive step”.

For the purposes of the present description and the following claims, the term “phr” (acronym for parts per hundreds of rubber) indicates the parts by weight of a given elastomeric compound component per 100 parts by weight of the elastomeric polymer, considered net of any extension oils.

Unless otherwise indicated, all the percentages are expressed as percentages by weight.

The elastomeric composition used in the tyre tread according to the present invention comprises 100 phr of an elastomeric polymer composition which comprises, preferably consists of at least one styrene-butadiene polymer (SBR) having a Tg ranging from −45° C. to −15° C. in amounts ranging from 40 to 100 phr, and optionally from 0 to 30 phr of at least one isoprene polymer (IR) having a Tg ranging from −80° C. to −50° C.

The glass transition temperature Tg of elastomeric polymers may be advantageously measured using a differential scanning calorimeter (DSC) according to methods well known to those skilled in the art [ISO 22768 “Rubber, green—Determination of the glass transition temperature by differential scanning calorimetry (DSC)”].

In the present context, styrene-butadiene (SBR) polymer is intended as a copolymer comprising monomer units of styrene and butadiene, with a percentage by weight of styrene preferably in the range from 10% to 55%, more preferably from 20% to 45%, and a weight percentage of vinyl (with respect to butadiene) preferably in the range from 10% to 70%, more preferably from 15% to 65%.

The styrene-butadiene polymer may contain, in addition to the styrene units and the butadiene units, a small amount, for example, equal to or less than 5% by weight, of additional monomer units such as isoprene, dimethylbutadiene, pentadiene, methylstyrene, ethylstyrene, divinylbenzene and diisopropenylbenzene.

Advantageously, the styrene-butadiene polymer has a Tg ranging from −40° C. to −20° C.

Preferably, the styrene-butadiene polymer is a random polymer.

Preferably, the styrene-butadiene polymer may have a weight average molecular weight comprised between 100,000 and 2,000,000 g/mol, preferably between 150,000 and 1,000,000, more preferably between 200,000 and 600,000 g/mol.

Preferably, the styrene-butadiene polymer is present in an amount ranging from 70 to 95 phr per 100 phr of a composition of elastomeric polymers.

The styrene-butadiene polymer may be prepared according to known techniques, for example as described in US2019062535, in US2019062529 or in U.S. Pat. No. 4,547,560.

In one embodiment, the styrene-butadiene polymer is prepared by solution polymerisation (S-SBR).

Typically, solution synthesis provides polymers with a narrow molecular weight distribution, fewer chain branches, higher molecular weight and higher cis-1,4-polybutadiene content than polymers obtainable in emulsion.

In another embodiment, the styrene-butadiene polymer is prepared by emulsion polymerisation (E-SBR).

The styrene-butadiene polymer may be a functionalised polymer, such as for example the functionalised SBRs described in US2019062535 (par. 9-13), in US2019062529 (par. 19-22) in WO2017/211876A1 (component a) or in WO2015/086039A1.

The functional group may be introduced into the styrene-butadiene polymer by processes known in the art such as, for example, during the production of the styrene-butadiene polymer by copolymerisation with at least one corresponding functionalised monomer containing at least one ethylene unsaturation; or by subsequent modification of the styrene-butadiene polymer by grafting at least one functionalised monomer in the presence of a free radical initiator (for example, an organic peroxide).

Alternatively, the functionalisation may be introduced by reaction with suitable terminating agents or coupling agents. In particular, the styrene-butadiene polymers obtained by anionic polymerisation in the presence of an organometallic initiator (in particular, an organolithium initiator) may be functionalised by reacting the residual organometallic groups derived from the initiator with suitable terminating agents or coupling agents such as, for example, amines, amides, imines, carbodiimides, alkyltin halides, substituted benzophenones, alkoxysilanes, aryloxy silanes, alkylthiols, alkyldithiolsilanes, carboxyalkylthiols, carboxyalkylthiolsilanes, and thioglycols.

Useful examples of terminating agents or coupling agents are known in the art and described, for example in patents EP2408626, EP2271682, EP3049447A1, EP2283046A1, EP2895515A1, WO2015/086039A1 and WO2017/211876A1.

In one embodiment, the elastomeric composition used for manufacturing the tyre tread according to the present invention comprises at least one styrene-butadiene polymer prepared by emulsion polymerisation (E-SBR), optionally functionalised, and at least one styrene-butadiene polymer prepared by solution polymerisation (S-SBR), optionally functionalised.

According to a preferred embodiment, the elastomeric composition used for manufacturing the tyre tread according to the present invention comprises (i) at least one styrene-butadiene polymer (preferably E-SBR) with a percentage by weight of styrene preferably in the range from 20% to 45% and a percentage by weight of vinyl (with respect to butadiene) preferably in the range from 10% to 20%, and (ii) at least one styrene-butadiene polymer (preferably S-SBR) with a percentage by weight of styrene preferably in the range from 20% to 45% and a percentage by weight of vinyl (with respect to butadiene) preferably in the range from 15% to 65%.

Commercial examples of SBR polymers useful in the present invention are Tufdene E581 and E680 polymers from Ashai-Kasei (Japan), SPRINTAN SLR4602, SLR3402 and SLR4630 from Trinseo (Germany), BUNA SL-4518, BUNA SE 1502 and BUNA CB 22 from Arlanxeo (Germany), Europrene 5543T, Europrene 1739 and Intol 1789 from ENI (Italy), HP 755 from Japan Synthetic Rubber Co. (Japan), and NIPOL NS 522 from Zeon Co. (Japan).

In the present context, isoprene polymer or isoprene rubber (IR) means a synthetic or natural elastomer obtained by 1,4-cis addition of isoprene. Preferably, the isoprene polymer is a natural rubber (NR). Isoprene polymers and natural rubbers are well known to those skilled in the field of tyres. The isoprene polymer may optionally be functionalised with the same terminating or coupling agents described above.

Advantageously, the isoprene polymer has a Tg ranging from −70° C. to −60° C.

Preferably, the isoprene polymer is present in an amount ranging from 5 to 30 phr per 100 phr of a composition of elastomeric polymers.

Commercial example of suitable isoprene polymer is SIR20 from Aneka Bumi Pratama or STR 20 from Thaiteck Rubber.

The elastomeric composition used for manufacturing the tyre tread according to the present invention further comprises from 15 to 50 phr of a mixture of resins which comprises, preferably consists of at least one resin with a softening temperature lower than 50° C., preferably lower than 40° C., in an amount ranging from 5 to 45 phr, at least one resin with a softening temperature higher than 110° C., preferably higher than 120° C., in an amount ranging from 5 to 45 phr, and optionally, from 0 to 40 phr of at least one resin with a softening temperature in the range from 50° C. to 110° C.

Advantageously, the elastomeric composition used for manufacturing the tyre tread according to the present invention comprises from 15 to 30 phr of a mixture of resins which comprises, preferably consists of at least one resin with a softening temperature lower than 50° C., preferably lower than 40° C., in an amount ranging from 5 to 15 phr, at least one resin with a softening temperature higher than 110° C., preferably higher than 120° C., in an amount ranging from 5 to 15 phr, and optionally, at least one resin with a softening temperature ranging from 50° C. to 110° C. in an amount ranging from 5 to 15 phr.

The glass transition temperature (Tg) and the softening temperature (Tr) of the resin may advantageously be measured using a differential scanning calorimeter (DSC) according to methods well known to those skilled in the art, such as the ASTM D 6604 method (Glass Transition Temperatures of Hydrocarbon resins by Differential Scanning calorimetry).

Preferably, the resins have a weight average molecular weight (Mw) comprised between 200 and 6,000 g/mol, preferably between 300 and 4,000 g/mol, more preferably between 400 and 3,000 g/mol.

The weight average molecular weight (Mw) of resins may be measured according to known techniques in the field such as, for example, by SEC (Size-Exclusion Chromatography) according to the ASTM D6579-11 method “Standard Practice for Molecular Weight Averages and Molecular Weight Distribution of Hydrocarbon, Rosin and Terpene Resins by Size-Exclusion Chromatography”.

The resins are preferably non-reactive resins, i.e. a non-cross-linkable polymer, preferably selected from the group comprising hydrocarbon resins, phenolic resins, natural resins and mixtures thereof.

The hydrocarbon resin may be aliphatic, aromatic or combinations thereof, meaning that the base polymer of the resin may consist of aliphatic and/or aromatic monomers.

The hydrocarbon resin may be natural (e.g. vegetable) or synthetic or derived from petroleum.

Preferably, the hydrocarbon resin is selected from homo- or copolymers of butadiene, homo- or copolymers of cyclopentadiene (CPD), dicyclopentadiene (DCPD), homo- or copolymers of terpene, homo- or copolymers of the C5 fraction and mixtures thereof, preferably DCPD/vinyl aromatic copolymers, DCPD/terpene copolymers, DCPD/C5 fraction copolymers, terpene/vinyl aromatic copolymers, C5 fractions/vinyl aromatic copolymers and combinations thereof.

Examples of vinyl aromatic monomers include styrene, alpha-methylstyrene, ortho-, meta-, para-methylstyrene, vinyl-toluene, para-terbutylstyrene, methoxy-styrenes, chloro-styrenes, vinyl-mesitylene, divinyl-benzenes, vinyl-naphthalenes, vinyl aromatic monomers derived from the C8-C10 fraction, in particular from C9.

Preferably, the hydrocarbon resin is selected from resins derived from coumarone-indene, styrene-indene, styrene-alkylstyrene, and aliphatic resins.

Specific examples of commercially available hydrocarbon resins are NOVARES resins, manufactured by Rain Carbon GmbH (such as Novares TL90, TT30 and C30 resins), UNILENE A 100 resin manufactured by Braskem, SYLVATRAXX 4401 resin manufactured by Kraton Corporation, IMPERA P1504, P2504 and Piccotac 1100 manufactured by Eastman, Escorez® 1102 resin manufactured by ExxonMobil, and Quintone A 100 resin manufactured by Zeon Chemicals.

The phenolic resin is selected from among the resins with alkylphenol-formaldehyde base, alkylphenolic resins modified with rosin, resins alkylphenol-acetylene based, modified alkylphenolic resins and terpene-phenol based resins.

Specific examples of commercially available phenolic resins which may be used in the present invention are p-t-butylphenol-formaldehyde resins, such as SL-1410 (manufactured by Sinolegend), SMD 31144 (manufactured by SI GROUP Inc.), DUREZ 32333 (manufactured by Sumitomo Bakelite); p-t-butylphenol-acetylene resins, such as KORESIN (manufactured by BASF Company); terpen-phenolic resins, such as SYLVARES TP 115 (manufactured by Kraton Corporation); and p-t-octylphenol-formaldehyde resins, such as SL-1801P (manufactured by Sinolegend), SP1068 or HRJ2118 (manufactured by SI GROUP), DUREZ 29095 (manufactured by Sumitomo Bakelite).

Natural resins may be terpene or rosin based.

Terpene-based resins are preferably homo or copolymers of alpha-pinene, beta-pinene, limonene, vinyl aromatic monomers (styrene) and/or aromatic monomers (phenol).

Examples of commercial terpene-based natural resins are: Piccolyte F90, Piccolyte F105, and Resin 2495, manufactured by PINOVA-DRT; Dercolyte A 115, Dercolyte TS105, Dercolyte M 115 and Dertophene 1510, manufactured by DRT.

The term rosin commonly indicates a mixture of isomeric organic acids (rosinic acids) characterised by a common structure, including three fused C6 rings, double bonds in different numbers and positions and a single carboxylic group, where the main component is abietic acid (C₂₀H₃₀O₂) and its dihydroabietic (C₂₀H₃₂O₂) and dehydroabietic (C₂₀H₂₈O₂) derivatives.

Examples of rosin-based resins are marketed by DRT under the name Dertoline, Hydrogral and Foral, and by Eastman under the name Staybelite, in particular Staybelite Ester 3-E.

Advantageously, the elastomeric composition typically also comprises at least one reinforcing filler which may be selected from those commonly used for vulcanised manufactured products, in particular for tyres, such as for example: carbon black, silica and silicates, alumina, calcium carbonate, or mixtures thereof. Carbon black, silica and mixtures thereof are particularly preferred.

Preferably, said reinforcing filler may be present in the elastomeric composition in an amount of from 10 phr to 120 phr, more preferably from 30 phr to 100 phr.

According to a preferred embodiment, said carbon black reinforcing filler may be selected from those having a surface area of not less than 20 m²/g (as determined by Statistical Thickness Surface Area—STSA—according to ISO 18852:2005).

According to a preferred embodiment, said silica reinforcing filler may be, for example, precipitated silica.

The silica reinforcing fillers which may advantageously be used in the present invention preferably have a BET surface area of from about 30 m²/g to 400 m²/g, more preferably from about 100 m²/g to about 250 m²/g, even more preferably from about 120 m²/g to about 220 m²/g. The pH of said silica reinforcing filler is generally from about 5.5 to about 7, preferably from about 5.5 to about 6.8.

Examples of silica reinforcing fillers which may be used in the present invention and are commercially available are the products known under the names of Hi-Sil® 190, Hi-Sil® 210, Hi-Sil® 233, Hi-Sil® 243, available from PPG Industries (Pittsburgh, Pa.); or the products known by the names of Ultrasil® VN2, Ultrasil® VN3, Ultrasil® 7000 from Evonik; or the products known by the names of Zeosil® 1165MP and 1115MP from Solvay.

Advantageously, the elastomeric composition comprises at least one silane coupling agent capable of interacting with the reinforcing filler and binding it to the elastomeric polymer during vulcanisation.

The coupling agents which are preferably used are silane-based ones which may be identified, for example, by the following structural formula (VI):

(R₂)₃Si—CₜH₂ₜ—X (VI)

wherein the R₂ groups, which may be equal or different from each other, are selected from: alkyl, alkoxy or aryloxy groups or halogen atoms, with the proviso that at least one of the R₂ groups is an alkoxy or an aryloxy group; t is an integer of between 1 and 6 inclusive; X is a group selected from nitrose, mercapto, amino, epoxide, vinyl, imide, chlorine, —(S)ᵤCₜH₂ₜ—Si—(R₂)₃ or —S—COR₂, wherein u and t are integers of between 1 and 6, ends included and the R₂ groups are as defined above.

Particularly preferred coupling agents are bis(3-triethoxysilylpropyl)tetrasulphide and bis(3-triethoxysilylpropyl)disulphide. Said coupling agents may be used as such or in a suitable mixture with an inert filler (such as carbon black) so as to facilitate their incorporation into the elastomeric composition.

Preferably, the coupling agent is added to the elastomeric composition in an amount ranging from 1 to 20% by weight, more preferably from 5 to 15% by weight, and even more preferably from 6 to 10% by weight with respect to the weight of silica.

The above elastomeric composition may be vulcanised according to known techniques, in particular with sulphur-based vulcanising systems commonly used for elastomeric polymers. To this end, after one or more thermo-mechanical processing steps, a sulphur-based vulcanising agent is incorporated in the composition, together with vulcanisation accelerants. In the final processing step, the temperature is generally kept below 120° C. and preferably below 100° C., so as to prevent any undesired pre-vulcanisation phenomenon.

The vulcanising agent used in the most advantageous manner is sulphur or sulphur-containing molecules (sulphur donors), with vulcanisation activating agents, accelerants and retardants which are known to those skilled in the art.

Said vulcanising agent is used in the elastomeric composition in an amount of from 0.1 phr to 12 phr, preferably from 0.5 phr to 10 phr, more preferably from 1 phr to 5 phr.

Activators which are particularly effective are the zinc compounds, and in particular ZnO, zinc salts of saturated or unsaturated fatty acids, such as for example zinc stearate, which are preferably formed in situ in the elastomeric composition starting from ZnO and fatty acids. Useful activators may also be oxides or inorganic salts of Fe, Cu, Sn, Mo and Ni as described in patent application EP 1231079. Stearic acid is typically used as an activator with zinc oxide.

Said vulcanisation activators are preferably employed in the elastomeric composition in an amount of from about 0.5 phr to about 10 phr, more preferably from 1 phr to 5 phr.

The accelerants which are commonly used may be selected from: dithiocarbamates, guanidine, thiourea, thiazoles, sulphenamides, thiurams, amines, xanthates or mixtures thereof.

Said vulcanisation accelerants are preferably used in the elastomeric composition in an amount of from about 0.5 phr to about 10 phr, more preferably from 1 phr to 5 phr.

Vulcanisation retardants which are commonly used may be selected, for example, from: urea, N-cyclohexyl-2-benzothiazolyl sulphenamide, N-cyclohexyl-phthalimide, N-cyclohexylthiophthalimide, N-nitrosodiphenylamine or mixtures thereof.

Said vulcanisation retardants are optionally used in the elastomeric composition in an amount lower than 1 phr, more preferably lower than 0.5 phr and, even more preferably, from about 0.1 phr to about 0.3 phr.

The elastomeric composition may comprise other commonly used additives based on the specific application for which the composition will be used. For example, the following may be added to the elastomeric composition: antioxidant, anti-ageing agents, plasticisers, adhesives, antiozonants (in particular of the p-phenylenediamine type), waxes, modified resins, fibres (for example Kevlar® paste), or mixtures thereof.

The vulcanisable elastomeric compound resulting from the elastomeric composition and the addition of the above additives may be prepared by mixing together the basic elastomeric components together with the other optionally present additives, according to the techniques known in the art. The mixing steps may be carried out, for example, using an open mixer of the cylinder type or an internal mixer of the type with tangential rotors (Banbury) or with interpenetrating rotors (Intermix), or in continuous mixers of the Ko-Kneader type (Buss) or of the co-rotating or counter-rotating twin-screw type.

### DRAWINGS

FIG. 1 schematically shows a semi-sectional view of a tyre for vehicle wheels according to the present invention;

FIG. 2 shows a diagram of the normalised values of the Tan δ/E′ ratio at the temperatures of 10° C., 23° C., 70° C. and 100° C. of the elastomeric compounds A-D of Example 1;

FIG. 3 shows a diagram of the normalised values of the Tan δ/E′ ratio at the temperatures of 10° C., 23° C., 70° C. and 100° C. of the elastomeric compounds E-H of Example 2.

### DETAILED DESCRIPTION OF THE INVENTION

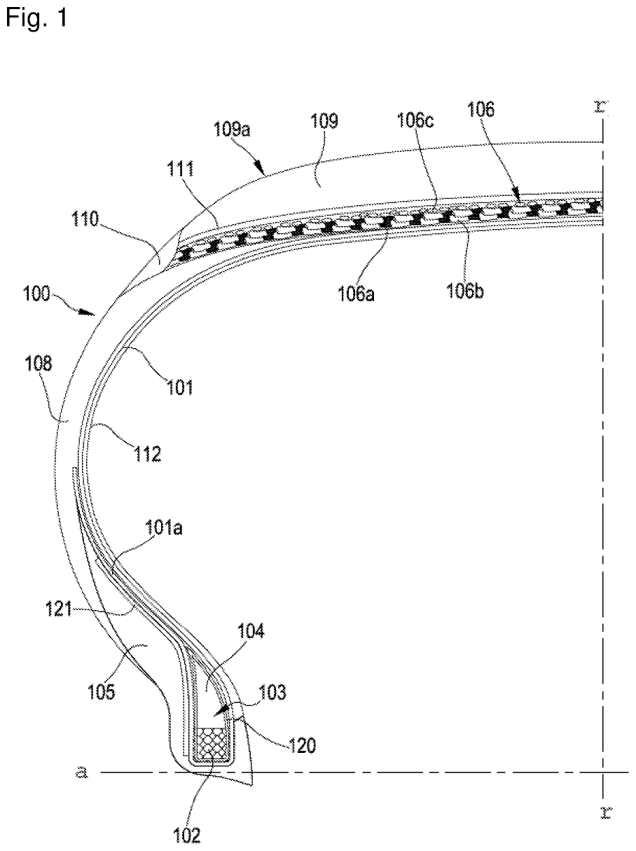

The present invention will be illustrated in further detail by means of an illustrative embodiment with reference to the accompanying FIG. 1, where “a” indicates an axial direction and “r” indicates a radial direction. For simplicity, FIG. 1 shows only a part of the tyre, the remaining part not shown being identical and disposed symmetrically with respect to the radial direction “r”.

The reference numeral 100 indicates in FIG. 1 a tyre for vehicle wheels, which generally comprises a carcass structure 101 having respectively opposite end flaps engaged with respective annular anchoring structures 102, called bead cores, possibly associated with a bead filler 104. The tyre area comprising the bead core 102 and the filler 104 forms a bead structure 103 intended for anchoring the tyre onto a corresponding mounting rim, not shown. Each bead structure 103 is associated to the carcass structure by folding back of the opposite lateral edges of the at least one carcass layer 101 around the bead core 102 so as to form the so-called carcass flaps 101a as shown in FIG. 1.

The carcass structure 101 is possibly associated with a belt structure 106 comprising one or more belt layers 106a, 106b placed in radial superposition with respect to one another and with respect to the carcass structure 101, having reinforcing cords typically made of metal. Such reinforcing cords may have crossed orientation with respect to a circumferential extension direction of the tyre 100. By “circumferential” direction we mean a direction generally facing according to the direction of rotation of the tyre, or in any case not very inclined with respect to the direction of rotation of the tyre.

The belt structure 106 further comprises at least one radially external reinforcing layer 106c with respect to the belt layers 106a, 106b. The radially external reinforcing layer 106c comprises textile or metal cords, disposed according to a substantially zero angle with respect to the circumferential extension direction of the tyre and immersed in the elastomeric material. Preferably, the cords are disposed substantially parallel and side by side to form a plurality of turns. Such turns are substantially oriented according to the circumferential direction (typically with an angle of between 0° and 5°), such direction being usually called “zero degrees” with reference to the laying thereof with respect to the equatorial plane X-X of the tyre. By “equatorial plane” of the tyre it is meant a plane perpendicular to the axis of rotation of the tyre and which divides the tyre into two symmetrically equal parts.

In a radially external position with respect to the carcass structure 101 and/or if present (as in the illustrated case) to the belt structure 106 a tread band 109 in vulcanised elastomeric compound obtained by vulcanisation of the vulcanisable elastomeric compound according to the present invention is applied.

In a radially external position, the tread band 109 has a rolling portion 109a intended to come into contact with the ground. Circumferential grooves, which are connected by transverse notches (not shown in FIG. 1) so as to define a plurality of blocks of various shapes and sizes distributed in the rolling portion 109a, are generally made in this portion 109a, which for simplicity is represented smooth in FIG. 1.

To optimise the performance of the tread, the tread band may be made in a two-layer structure.

Such two-layer structure comprises the rolling layer or portion 109a (called cap) and a substrate 111 (called base) forming the so-called cap-and-base structure. It is thus possible to use an elastomeric material capable of providing a low rolling resistance for the cap 109a and at the same time high resistance to wear and to the formation of cracks while the elastomeric material of the substrate 111 may be particularly aimed at a low hysteresis to cooperate in reducing rolling resistance. One or both layers of the cap-and-base structure may be made with a vulcanised elastomeric compound obtained by vulcanising the vulcanisable elastomeric compound according to the present invention. The under-layer 111 of vulcanised elastomeric compound may be disposed between the belt structure 106 and the rolling portion 109a.

Moreover, respective sidewalls 108 of vulcanised elastomeric compound are further applied in an axially external position to said carcass structure 101, each extending from one of the lateral edges of the tread band 109 up to the respective bead structure 103.

A strip consisting of elastomeric compound 110, commonly known as “mini-sidewall”, of vulcanised elastomeric compound may optionally be provided in the connecting zone between sidewalls 108 and the tread band 109, this mini-sidewall generally being obtained by co-extrusion with the tread band 109 and allowing an improvement of the mechanical interaction between the tread band 109 and the sidewalls 108. Preferably, the end portion of sidewall 108 directly covers the lateral edge of the tread band 109.

In some specific embodiments, such as the one illustrated and described herein, the stiffness of the bead 103 may be improved by providing a reinforcing layer 120 generally known as a “flipper” in the tyre bead.

The flipper 120 is wrapped around the respective bead core 102 and the bead filler 104 so as to at least partially surround them. The flipper 120 is disposed between the carcass layer 101 and the bead structure 103. Usually, the flipper 120 is in contact with the carcass layer 101 and said bead structure 103. The flipper 120 typically comprises a plurality of metal or textile cords incorporated in a vulcanised elastomeric compound.

In some specific embodiments, such as the one illustrated and described herein, the bead structure 103 may further comprise a further protective layer 121 which is generally known by the term of “chafer”, or protective strip, and which has the function to increase the rigidity and integrity of the bead structure 103.

The chafer 121 usually comprises a plurality of cords incorporated in a vulcanised elastomeric compound; such cords are generally made of textile material (for example aramid or rayon), or of metallic material (for example steel cords).

Optionally, an anti-abrasive strip 105 is disposed so as to wrap the bead structure 103 along the axially internal and external and radially internal areas of the bead structure 103, thus interposing itself between the latter and the wheel rim when the tyre 100 is mounted on the rim.

Moreover, a radially internal surface of tyre 100 is preferably internally lined by a layer of substantially airtight elastomeric material, or so-called liner 112.

Preferably but non-exclusively, the tyre 100 for motor vehicles is of the HP (High-Performance) or UHP (Ultra High-Performance) type, i.e. it is a tyre capable of withstanding maximum speeds of at least 190 Km/h, up to over 300 Km/h. Examples of such tyres are those belonging to the classes “T”, “U”, “H”, “V”, “Z”, “W”, “Y”.

According to an embodiment not shown, the tyre may be a tyre for motorcycle wheels. The profile of the straight section of the tyre for motorcycle (not shown) has a high transversal curvature since it must guarantee a sufficient footprint area in all the inclination conditions of the motorcycle. The transverse curvature is defined by the value of the ratio between the distance f of the ridge of the tread from the line passing through the laterally opposite ends of the tread itself, measured on the equatorial plane of the tyre, and the width C defined by the distance between the laterally opposite ends of the tread itself. A tyre with high transverse curvature indicates a tyre whose transverse curvature ratio (f/C) is at least 0.20.

The building of the tyre 100 as described above is carried out by assembling respective semi-finished products onto a forming drum, not shown, by at least one assembly device.

At least a part of the components intended to form the carcass structure 101 of the tyre 100 is built and/or assembled on the forming drum. More particularly, the forming drum is intended to first receive the possible liner 112, and then the carcass ply 101. Thereafter, devices non shown coaxially engage one of the annular anchoring structures 102 around each of the end flaps, position an external sleeve comprising the belt structure 106 and the tread band 109 in a coaxially centred position around the cylindrical carcass sleeve and shape the carcass sleeve according to a toroidal configuration through a radial expansion of the carcass ply 101, so as to cause the application thereof against a radially internal surface of the external sleeve.

After building of the green tyre 100, a moulding and vulcanisation treatment is generally carried out in order to determine the structural stabilisation of the tyre 100 through vulcanisation of the elastomeric compounds, as well as to impart a desired tread pattern on the tread band 109 and to impart any distinguishing graphic signs at the sidewalls 108.

The present invention will be further illustrated below by means of a number of preparatory examples, which are provided for indicative purposes only and without any limitation of the present invention.

### EXAMPLES

### Methods of Analysis

Scorching time (Scorch): it is the time required, expressed in minutes, to have a +5 points increase in Mooney viscosity, measured according to ISO 289-2 (1994), at 127° C.

Viscosity: the measurement was carried out at 100° C. on the final elastomeric composition before vulcanisation according to the ISO 289-1 (1994) procedure.

MDR rheometric analysis: the analysis was carried out according to the ISO 6502 method, with an Alpha Technologies model MDR2000 rheometer, at 170° C. and for 30 minutes.

The applied oscillation frequency was 1.66 Hz with an oscillation width of ±0.5°. The time required to achieve an increase of two rheometric units (TS2) and to respectively reach 30% (T30), 60% (T60) and 90% (T90) of the maximum torque MH was measured. The maximum torque value MH and the minimum torque value ML were also measured.

IRHD hardness: IRHD hardness (23° C.) was measured on vulcanised compounds according to ISO 48: 2007.

Glass transition temperature (Tg): The glass transition temperature Tg of the elastomeric polymers and of the vulcanised compounds, determined on the peak value of the Tan Delta, was measured by dynamo-mechanical analysis (DMA). In detail, the samples were analysed with an EPLEXOR® 150 (GABO) device by carrying out a temperature scan from −80° C. to +30° C. with temperature increases of 2° C./min, applying a dynamic tensile deformation of the 0.1% at a frequency of 1 Hz. The specimens had the following dimensions: thickness 1 mm, width 10 mm, length 46 mm, reference length 29 mm (represents the free length that participates in the deformation while the two clamps block the ends of the specimen).

Stress deformation properties: the static mechanical properties were measured according to ISO 37:2005, on O-rings. Strength was evaluated at different elongations (100% and 300%, respectively, CA1 and CA3). CR (load at break) and AR (elongation at break) were also measured.

Dynamic Mechanical Analysis (MTS): the dynamic mechanical properties were measured using an Instron dynamic device in compression and tension operation by the following method. A sample of vulcanised elastomeric cylindrical compositions (height=25 mm; diameter=14 mm), preload in compression up to 25% of longitudinal deformation with respect to the initial length and maintained at the predetermined temperature (−10° C., 23° C., 70° C. or 100° C.) during the test was subjected to a dynamic sinusoidal voltage with amplitude±3.5% with respect to the length of the preload, at a frequency of 10 Hz for the test at 10° C., and 100 Hz for the tests at 23° C., 70° C., and 100° C.

The dynamic mechanical properties are expressed in terms of dynamic elastic modulus (E′) and Tan delta (loss factor). The Tan delta value was calculated as the ratio between the viscous dynamic module (E″) and the dynamic elastic modulus (E′).

Abrasion: abrasion resistance was evaluated according to DIN 53516, where the sample is forced against a rotating drum and the weight loss (mg) is measured. The lower the value, the greater the abrasion resistance of the sample.

### Example 1

### Preparation of Elastomeric Compounds for High-Performance Tyre Treads

The composition of the elastomeric compounds A-D for high-performance tyre treads is shown in the following Table 1. All values are expressed in phr.

TABLE 1

| | Com- | Com- | Com- | Com- |
|---|---|---|---|---|
| | pound A | pound B | pound C | pound D |
| | Reference | Comparison | Invention | Invention |
| NR | 16.2 | 16.2 | 16.2 | 16.2 |
| E-SBR | 24.2 | 24.2 | 24.2 | 24.2 |
| S-SBR | 91 | 91 | 91 | 91 |
| Carbon black | 85 | 85 | 85 | 85 |
| Silica | 25 | 25 | 25 | 25 |
| Coupling agent | 2 | 2 | 2 | 2 |
| Oil | 2 | 2 | 2 | 2 |
| Resin 1 | | 20 | 15 | 7.5 |
| Resin 2 | 2.4 | 2.4 | — | — |
| Resin 3 | — | — | — | 10 |
| Resin 4 | 20 | — | — | — |
| Resin 5 | — | — | 7.5 | 5 |
| Stearic acid | 1.5 | 1.5 | 1.5 | 1.5 |
| Zinc salt | 2 | 2 | 2 | 2 |
| ZnO | 1 | 1 | 1 | 1 |
| Wax | 2 | 2 | 2 | 2 |
| Antidegradant | 5 | 5 | 5 | 5 |
| Accelerant | 1.5 | 1.5 | 1.5 | 1.5 |
| Sulphur | 2 | 2 | 2 | 2 |

NR: natural rubber (Standard Thai Rubber STR 20 - Thaiteck Rubber);
E-SBR: styrene-butadiene rubber comprising 40% by weight of styrene and 15-18% by weight of vinyl with respect to the butadiene content, produced by emulsion polymerisation, extended with 37.5 parts of TDAE oil per 100 parts of dry polymer (INTOL ® 1789; ENI; Tg: −37° C.)
S-SBR: styrene-butadiene rubber partially coupled to Si, comprising 25% by weight of styrene and 63% by weight of vinyl with respect to the butadiene content, produced by anionic polymerisation in solution using an organo-lithium initiator; extended with 37.5 parts of TDAE oil for every 100 parts of dry polymer (SPRINTAN ™ SLR 4630-SCHKOPAU; Trinseo; Tg: −28° C.)
Carbon black: N234 from Cabot Corporation;
Silica: ZEOSIL ® 1165 MP, standard grade with surface area of approx. 175 m²/g from Solvay;
Coupling agent: bis[3-(triethoxysilyl)propyl]tetrasulphide JH-S69 from ChemSpec Ltd.;
Oil: MES (Mild Extract Solvated) CLEMATIS MS from ENI;
Resin 1: Triethylene glycol ester of hydrogenated rosin (Staybelite Ester 3-E; Eastman; Tg: −19° C.; Tr: <15° C.);
Resin 2: Hydrocarbon resin (Novares TT30; Reutgers Germany GmbH; Tr: 20/35° C.);
Resin 3: Alpha-methylstyrenic resin (IMPERA P2504; EASTMAN; Tr: 105° C.);
Resin 4: Indene styrene resin (Novares TL90; Reutgers Germany GmbH; Tr: 90° C.);
Resin 5: Phenolic resin (SL-1410; Sinolegend; Tr: 125° C.);
Zinc salt: Zinc stearate Aktiplast ST (Rheinchemie)
ZnO: Standard Zn oxide from A-Esse;
Antidegradant: N-(1,3-dimethylbutyl)-N′-phenyl-p-phenylene-diamine SANTOFLEX 6PPD from EASTMAN;
Accelerant: N-cyclohexylbenzothiazole-2-sulphenamide RUBENAMID C EG/C from GENERAL QUIMICA.

### Evaluation of the Elastomeric Compounds A-D Performance

Starting from the elastomeric compositions shown in Table 1, the corresponding elastomeric compounds were prepared according to the following process.

The mixing of the components was carried out in two steps using an internal mixer (Banbury, Intermix or Brabender)

In the first mixing step (1), all the ingredients were introduced with the exception of vulcanisers and accelerants. The mixing was continued for a maximum time of 5 minutes, reaching a temperature of approximately 145° C. Subsequently, in the second mixing step (2), again carried out using an internal mixer, the vulcanisers and accelerants were added, and the mixing was continued for about 4 minutes while maintaining the temperature below 100° C. The compounds were then unloaded. After cooling and at least 12 hours from preparation, some samples of the compounds were vulcanised in a press at 170° C. for 10 min to give the specimens useful for mechanical characterizations.

The features of each elastomeric compound A-D were evaluated as previously described in the section “analysis methods” and the results are summarised in the following Table 2.

TABLE 2

| | Reference | Comparison | Invention | Invention |
|---|---|---|---|---|
| | com- | com- | com- | com- |
| | pound A | pound B | pound C | pound D |
| Scorching time | 30 | 26 | 19 | 23 |
| Viscosity | 84 | 84 | 80 | 81 |
| Density | 1.191 | * | 1.188 | 1.188 |
| IRHD hardness | 76 | 75 | 75 | 75 |
| Tg peak | −14 | −17.5 | −16.5 | −14 |
| DIN abrasion | 62 | 62 | 70 | 69 |

MDR

| | | | | |
|---|---|---|---|---|
| ML | 3.9 | 4.1 | 3.5 | 3.6 |
| MH | 13.7 | 14.3 | 13.0 | 13.2 |
| TS2 | 2.0 | 1.9 | 1.6 | 1.8 |
| T30 | 2.3 | 2.3 | 1.8 | 2.0 |
| T60 | 3.0 | 2.9 | 2.4 | 2.7 |
| T90 | 4.5 | 4.5 | 3.8 | 4.1 |

Static properties

| | | | | |
|---|---|---|---|---|
| Ca1 | 2.0 | 2.2 | 1.9 | 1.9 |
| Ca3 | 8.2 | 9.3 | 8.0 | 8.0 |
| AR | 15.8 | 13.8 | 16.1 | 14.0 |
| CR | 562 | 458 | 595 | 508 |

Dynamic properties

| | | | | |
|---|---|---|---|---|
| E′ 10 Hz/10° C. | 12.8 | 11.3 | 12.4 | 12.5 |
| Tanδ 10 Hz/10° C. | 0.632 | 0.566 | 0.631 | 0.642 |
| E′ 100 Hz/23° C. | 13.3 | 12.4 | 13.0 | 13.2 |
| Tanδ 100 Hz/23° C. | 0.674 | 0.604 | 0.675 | 0.682 |
| E′ 100 Hz/70° C. | 6.4 | 6.4 | 6.4 | 6.2 |
| Tanδ 100 Hz/70° C. | 0.384 | 0.356 | 0.388 | 0.387 |
| E′ 10 Hz/100° C. | 5.5 | 5.6 | 5.5 | 5.3 |
| Tanδ 100 Hz/100° C. | 0.305 | 0.286 | 0.307 | 0.306 |

* value not determined

The results obtained showed that, compared to the reference compound A:
all the compounds showed values of static mechanical properties, hardness, abrasion and MDR comparable and substantially in line with the reference compound A, satisfying the need not to penalise the features of processability, mechanical strength and wear resistance;
the comparison compound B, comprising a single resin with low Tr, showed a reduction of the elastic dynamic modulus (E′) at low temperatures and a general reduction of the hysteresis (Tan δ) at all temperatures. The result was not satisfactory, as the improvement in grip performance in the wet was at the expense of those at high temperatures, with a shift in the useful range of working temperatures towards lower temperatures;
the compound C of the invention, comprising two resins, one with a low Tr and one with a high Tr, had a wider useful range of working temperatures, providing a satisfactory result. In fact, compound C showed a reduction of the dynamic elastic modulus (E′) at low temperatures (10° C. and 23° C.) and comparable at high temperatures (75° C. and 100° C.), while the hysteresis (Tan δ) was comparable or slightly better at all temperatures. Modulus reduction at low temperatures ensures greater mobility and better grip on wet surfaces, while comparable values at high temperatures maintain grip performance on dry surfaces;
the compound D of the invention, comprising three resins, one with a low Tr, one with an intermediate Tr, and one with a high Tr, had a behaviour similar to that of the compound C, with a wider useful range of working temperatures, and a more than satisfactory result. In particular, compound D showed a reduction in the dynamic elastic modulus (E′) at all temperatures, and more relevant at 10° C., while the hysteresis (Tan δ) was slightly better at low temperatures (10° C. and 23° C.) and comparable at high temperatures (75° C. and 100° C.). Again there was an improvement in wet grip without affecting the grip performance on dry surfaces.

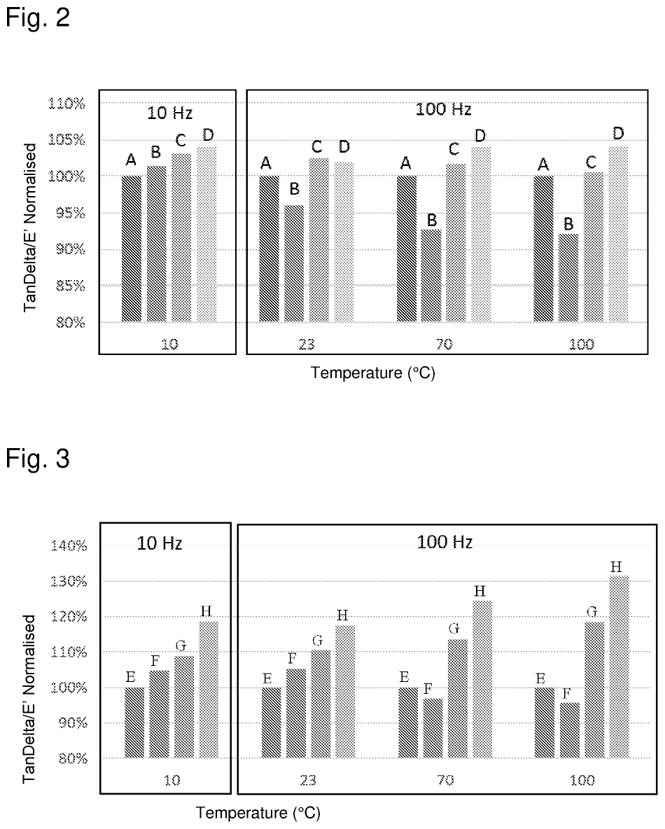

FIG. 2 shows the normalised values of the Tan δ/E′ ratio to 100 for each compound A-D at the temperature of 10° C., 23° C., 70° C. and 100° C. Compound D, comprising the ternary mixture of resins, proved to be the compound with the best balance in the grip performance at all temperatures, with a wide useful range of working temperatures, and compound C however showed more than satisfactory values.

### Example 2

### Preparation of Elastomeric Compounds for High-Performance Tyre Treads

The composition of the elastomeric compounds E-H for high-performance tyre treads is shown in the following Table 3. All values are expressed in phr.

TABLE 3

| | Com- | Com- | Com- | Com- |
|---|---|---|---|---|
| | pound E | pound F | pound G | pound H |
| | Reference | Comparison | Invention | Invention |
| NR | 26.2 | 26.2 | 26.2 | 26.2 |
| S-SBR | 101.45 | 101.45 | 101.45 | 101.45 |
| Carbon black | 85 | 85 | 85 | 85 |
| Silica | 25 | 25 | 25 | 25 |
| Coupling agent | 2 | 2 | 2 | 2 |
| Oil | 5.1 | 5.1 | 5.1 | 5.1 |
| Resin 1 | — | 20 | 12.5 | 5 |
| Resin 2 | 2.4 | 2.4 | — | — |
| Resin 3 | — | — | — | 7.5 |
| Resin 4 | 20 | — | — | — |
| Resin 5 | — | — | 10 | 10 |
| Zinc salt | 2 | 2 | 2 | 2 |
| Stearic acid | 1.5 | 1.5 | 1.5 | 1.5 |
| ZnO | 1 | 1 | 1 | 1 |
| Wax | 2 | 2 | 2 | 2 |
| Antidegradant | 5 | 5 | 5 | 5 |
| Accelerant | 1.5 | 1.5 | 1.5 | 1.5 |
| Sulphur | 2 | 2 | 2 | 2 |

NR: natural rubber (Standard Thai Rubber STR 20 - Thaiteck Rubber);
S-SBR: partially Si-coupled styrene-butadiene rubber produced by anionic solution polymerisation using an organo-lithium initiator; extended with 37.5 parts of TDAE oil per every 100 parts of dry polymer (SPRINTAN ™ SLR 4630-SCHKOPAU; Trinseo; Tg: −28° C.)
Carbon black: N234 from Cabot Corporation;
Silica: ZEOSIL ® 1165 MP, standard grade with surface area of approx. 175 m²/g from Solvay;
Coupling agent: bis[3-(triethoxysilyl)propyl]tetrasulphide JH-S69 from ChemSpec Ltd.;
Oil: MES (Mild Extract Solvated) CLEMATIS MS from ENI;
Resin 1: Triethylene glycol ester of hydrogenated rosin (Staybelite Ester 3-E; Eastman; Tg: −19° C.; Tr: <15° C.);
Resin 2: Hydrocarbon resin (Novares TT30; Reutgers Germany GmbH; Tr: 20/35° C.);
Resin 3: Hydrocarbon resin (Escorez 1102; ExxonMobil; Tr: 95/105° C.);
Resin 4: Indene styrene resin (Novares TL90; Reutgers Germany GmbH; Tr: 90° C.);
Resin 5: Phenolic resin (SL-1410; Sinolegend; Tr: 125° C.);
Zinc salt: Zinc stearate Aktiplast ST (Rheinchemie)
ZnO: Standard Zn oxide from A-Esse;
Antidegradant: N-(1,3-dimethylbutyl)-N′-phenyl-p-phenylene-diamine SANTOFLEX 6PPD from EASTMAN;
Accelerant: N-cyclohexylbenzothiazole-2-sulphenamide RUBENAMID C EG/C from GENERAL QUIMICA.

### Evaluation of the Elastomeric Compounds E-H Performance

Starting from the elastomeric compositions shown in Table 3, the corresponding elastomeric compounds were prepared according to the following process.

The mixing of the components was carried out in two steps using an internal mixer (Banbury, Intermix or Brabender)

In the first mixing step (1), all the ingredients were introduced with the exception of vulcanisers and accelerants. The mixing was continued for a maximum time of 5 minutes, reaching a temperature of approximately 145° C. Subsequently, in the second mixing step (2), again carried out using an internal mixer, the vulcanisers and accelerants were added, and the mixing was continued for about 4 minutes while maintaining the temperature below 100° C. The compounds were then unloaded. After cooling and at least 12 hours from preparation, some samples of the compounds were vulcanised in a press at 170° C. for 10 min to give the specimens useful for mechanical characterizations.

The features of each elastomeric compound E-H were evaluated as previously described in the section “analysis methods” and the results are summarised in the following Table 4.

TABLE 4

| | Com- | Com- | Com- | Com- |
|---|---|---|---|---|
| | pound E | pound F | pound G | pound H |
| | Reference | Comparison | Invention | Invention |
| Scorching time | 30 | * | 17.7 | 18.6 |
| Viscosity | 90 | 86 | 82 | 85 |
| Density | * | 1.188 | 1.186 | 1.183 |
| IRHD hardness | 77 | 76 | 74 | 74 |
| Tg peak | −13 | −20 | −17 | −16 |
| DIN abrasion | 59 | 58 | 66 | 69 |

MDR

| | | | | |
|---|---|---|---|---|
| ML | 4.4 | 4.2 | 3.6 | 3.7 |
| MH | 14.6 | 14.6 | 13.0 | 12.8 |
| TS2 | 2.0 | 1.9 | 1.5 | 1.5 |
| T30 | 2.3 | 2.2 | 1.7 | 1.7 |
| T60 | 3.1 | 2.9 | 2.3 | 2.3 |
| T90 | 4.6 | 4.4 | 3.7 | 3.8 |

Static properties

| | | | | |
|---|---|---|---|---|
| Ca1 | 2.3 | 2.1 | 1.9 | 1.8 |
| Ca3 | 9.4 | 9.0 | 8.0 | 7.7 |
| AR | 15.6 | 15.8 | 15.7 | 16.3 |
| CR | 517 | 535 | 575 | 609 |

Dynamic properties

| | | | | |
|---|---|---|---|---|
| E′ 10 Hz/10° C. | 12.3 | 10.6 | 12.0 | 11.2 |
| Tanδ 10 Hz/10° C. | 0.592 | 0.535 | 0.629 | 0.640 |
| E′ 100 Hz/23° C. | 12.3 | 11.5 | 12.5 | 12.2 |
| Tanδ 100 Hz/23° C. | 0.635 | 0.583 | 0.665 | 0.690 |
| E′ 100 Hz/70° C. | 6.6 | 6.4 | 6.2 | 5.6 |
| Tanδ 100 Hz/70° C. | 0.371 | 0.349 | 0.396 | 0.392 |
| E′ 100 Hz/100° C. | 5.8 | 5.8 | 5.4 | 4.7 |
| Tanδ 100 Hz/100° C. | 0.289 | 0.277 | 0.319 | 0.308 |

* value not determined

The results obtained showed that, compared to the reference compound E:
all the compounds showed values of static mechanical properties, hardness, abrasion and MDR comparable and substantially in line with the reference compound E, satisfying the need not to penalise the features of processability, mechanical strength and wear resistance;

The comparison compound F, comprising a single resin with low Tr, showed a reduction of the elastic dynamic modulus (E′) at low temperatures and a general reduction of the hysteresis (Tan δ) at all temperatures. The result was not satisfactory, as the improvement in grip performance in the wet was at the expense of those at high temperatures, with a shift in the useful range of working temperatures towards lower temperatures;
the compound G of the invention, comprising two resins, one with a low Tr and one with a high Tr, had a wider useful range of working temperatures, providing a satisfactory result. In fact, compound G showed a comparable value of the elastic dynamic modulus (E′) at low temperatures (10° C. and 23° C.) and reduced at high temperatures (75° C. and 100° C.), while the hysteresis (Tan δ) was significantly greater at all temperatures. These results ensured better grip on both wet and dry surfaces;
the compound H of the invention, comprising three resins, one with a low Tr, one with an intermediate Tr, and one with a high Tr, had a behaviour similar to that of the compound C, with a wider useful range of working temperatures, and a more than satisfactory result. In particular, the compound H showed a consistent reduction of the elastic dynamic modulus (E′) at all temperatures (less relevant at 10° C.), while the hysteresis (Tan δ) showed a greater value at all temperatures. Also in this case there was an improvement in grip on both wet and dry surfaces.

FIG. 3 shows the normalised values of the Tan δ/E′ ratio to 100 for each compound E-H at the temperature of 10° C., 23° C., 70° C. and 100° C. Compound H, comprising the ternary mixture of resins, proved to be the compound with the best balance in the grip performance at all temperatures, with a wide useful range of working temperatures, and compound G however showed more than satisfactory values.

1-10. (canceled)

11. A tyre for vehicle wheels, comprising
a carcass structure with opposite side edges associated with respective bead structures;
optionally, a belt structure applied in a radially external position with respect to the carcass structure;
a tread band applied in a radially external position with respect to the carcass structure, the belt structure, or both;
wherein the tread band comprises a vulcanised elastomeric compound comprising, before vulcanization, a vulcanisable elastomeric compound comprising, before mixing, an elastomeric composition, wherein the elastomeric composition comprises:
(i) 100 phr of an elastomeric polymer composition comprising:
a. at least one styrene-butadiene polymer (SBR) having a Tg ranging from −45° C. to −15° C. in an amount ranging from 40 phr to 100 phr, and
b. from 0 phr to 30 phr of at least one isoprene polymer (IR) having a Tg ranging from −80° C. to −50° C.,
(ii) from 15 phr to 50 phr of a resin mixture comprising:
a. at least one resin with a softening temperature lower than 50° C. in an amount ranging from 5 phr to 45 phr,
b. at least one resin with a softening temperature higher than 110° C. in an amount ranging from 5 phr to 45 phr, and
(iii) from 1 phr to 130 phr of at least one reinforcing filler; and
(iv) from 0.1 phr to 12 phr of at least one vulcanising agent.

12. The tyre for vehicle wheels according to claim 11, wherein the at least one styrene-butadiene polymer has a Tg ranging from −40° C. to −25° C.

13. The tyre for vehicle wheels according to claim 11, wherein the at least one isoprene polymer has a Tg ranging from −70° C. to −60° C.

14. The tyre for vehicle wheels according to claim 11, wherein the at least one styrene-butadiene polymer comprises a weight percentage of styrene ranging from 10% to 55%, and a weight percentage of vinyl (relative to butadiene) ranging from 10% to 70%.

15. The tyre for vehicle wheels according to claim 11, wherein the elastomeric polymer composition comprises at least one styrene-butadiene polymer prepared by emulsion polymerisation (E-SBR), optionally functionalised, and at least one styrene-butadiene polymer prepared by solution polymerisation (S-SBR), optionally functionalised.

16. The tyre for vehicle wheels according to claim 15, wherein the E-SBR polymer comprises a weight percentage of styrene ranging from 20% to 45% and a weight percentage of vinyl (relative to butadiene) ranging from 10% to 20%.

17. The tyre for vehicle wheels according to claim 15, wherein the S-SBR polymer comprises a weight percentage of styrene ranging from 20% to 45% and a weight percentage of vinyl (relative to butadiene) ranging from 15% to 65%.

18. The tyre for vehicle wheels according to claim 11, wherein the resin mixture comprises:
a. at least one resin with a softening temperature lower than 50° C. in an amount ranging from 5 phr to 15 phr,
b. at least one resin with a softening temperature higher than 110° C. in an amount ranging from 5 phr to 15 phr, and
c. optionally, at least one resin with a softening temperature ranging from 50° C. to 110° C. in an amount ranging from 5 to 15 phr.

19. The tyre for vehicle wheels according to claim 11, wherein the resin mixture comprises:
a. at least one resin with a softening temperature lower than 50° C. in an amount ranging from 5 phr to 15 phr,
b. at least one resin with a softening temperature higher than 110° C. in an amount ranging from 5 phr to 15 phr, and
c. at least one resin with a softening temperature ranging from 50° C. to 110° C. in an amount ranging from 5 phr to 15 phr.

20. A vulcanisable elastomeric compound comprising, before mixing, an elastomeric composition, wherein the elastomeric composition comprises:
(i) 100 phr of an elastomeric polymer composition comprising,
a. at least one styrene-butadiene polymer (SBR) having a Tg ranging from −45° C. to −15° C. in an amount ranging from 40 to 100 phr, and
b. from 0 to 30 phr of at least one isoprene polymer (IR) having a Tg ranging from −80° C. to −50° C.,
(ii) from 15 phr to 50 phr of a resin mixture comprising;
a. at least one resin with a softening temperature lower than 50° C. in an amount ranging from 5 phr to 45 phr,
b. at least one resin with a softening temperature higher than 110° C. in an amount ranging from 5 phr to 45 phr, and
c. from 0 phr to 40 phr of at least one resin with a softening temperature ranging from 50° C. to 110° C.,
(iii) from 1 phr to 130 phr of at least one reinforcing filler, and
(iv) from 0.1 phr to 12 phr of at least one vulcanising agent.
